(19) United States
(12) Patent Application Publication
(10) Pub. No.: US 2002/0053942 A1
(43) Pub. Date: May 9, 2002

(54) Voltage boost system and image sensing apparatus including voltage boost system

(76) Inventor: Takashi Tanimoto, Gifu-ken (JP)

Correspondence Address: ERIC L. PRAHL, Fish & Richardson P.C., 225 Franklin Street, Boston, MA, 02110-2804, US

(21) Appl. No.: 10/010,396

(22) Filed: Nov. 5, 2001

(30) Foreign Application Priority Data
Nov. 7, 2000 (JP) 2000-338709

(51) Int. Cl. G05F 3/02

(52) U.S. Cl. 327/536

(57) ABSTRACT

A voltage boost system that prevents power consumption from increasing. The voltage boost system has a load device including a high potential power supply terminal and a low potential power supply terminal. A power supply generates a first potential by that is greater than a ground potential. A voltage booster is connected to the power supply to increase the first potential and generate a second potential that is greater than the first potential. The second potential of the voltage booster is provided to the high potential power supply terminal of the load device, and the first potential of the power supply is provided to the low potential power supply terminal of the load device.

### BACKGROUND OF THE INVENTION

The present invention relates to a voltage boost system, and more particularly, to a voltage boost system for increasing voltage supplied from a sole power supply and generating a predetermined boosted voltage.

A voltage boost circuit that generates different drive voltages from a sole power supply is employed in electronic devices. For example, in a charge coupled device (CCD) shift register, when CCD signal charges are output by a floating diffusion amp (FDA), the FDA is driven or reset by a boosted voltage of a voltage booster.

In the CCD, a photoelectric-transferred signal charge produces a potential change in a floating diffusion (FD) section. Based on the potential change, an output buffer generates an output signal voltage (image sensing signal). Then, the potential of the FD section is reset before providing the FD section with the signal charge. The reset operation requires voltage that is higher than the voltage used by a drive circuit of the CCD. Thus, the voltage boosted by the voltage booster is used as a reset voltage.

The employment of the voltage booster in this manner enables the electronic device to be designed with fewer restrictions and allows the number of power supplies in the electronic device to be decreased to one. However, the increase in the power consumed by a load device due to the boosted voltage cannot be ignored.

In the output buffer of the CCD, it is required that the drive voltage of the output buffer be high to detect the potential change in the FD section. However, such high voltage may not necessarily be required to drive the output buffer. Accordingly, the supply of the boosted voltage to the output buffer increases power consumption and hinders power conservation. Such problem occurs not only in the CCD output buffer but also in the circuits and elements of which drive voltages do not necessarily require the full boosted voltage.

### SUMMARY OF THE INVENTION

It is an object of the present invention to provide a voltage boost system that prevents power consumption from increasing.

To achieve the above object, the present invention provides a voltage boost system provided with a load device including a pair of terminals. A power supply generates a first potential. A voltage booster is connected to the power supply to generate a second potential by boosting the first potential. The second potential is provided to one of the pair of the terminals, and the first potential is provided to another one of the pair of the terminals.

A further perspective of the present invention is an image sensing apparatus including a solid-state image sensing apparatus for accumulating charges in correspondence with an object image and transferring the accumulated charges. A drive circuit is connected to the solid-state image sensing apparatus to drive the solid-state image sensing apparatus so that the solid-state image sensing apparatus accumulates charges for a predetermined time and transfers the accumulated charges. An output circuit is connected to the solid-state image sensing apparatus to generate an image sensing signal from the charges transferred by the solid-state image sensing apparatus. The output circuit has a pair of terminals. A power supply generates a first potential. A voltage booster is connected to the power supply to generate a second potential by boosting the first potential. One of the pair of the terminals is provided with the second potential of the voltage booster. Another one of the terminals of the output circuit is provided with the first potential of the power supply.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing a voltage boost system according to a preferred embodiment of the present invention; and

FIG. 2 is a schematic block diagram of an image sensing apparatus according to a preferred embodiment of the present invention.

### DETAILED DESCRIPTION OF THE PREFERED EMBODIMENTS

In the drawings, like numerals are used for like elements throughout.

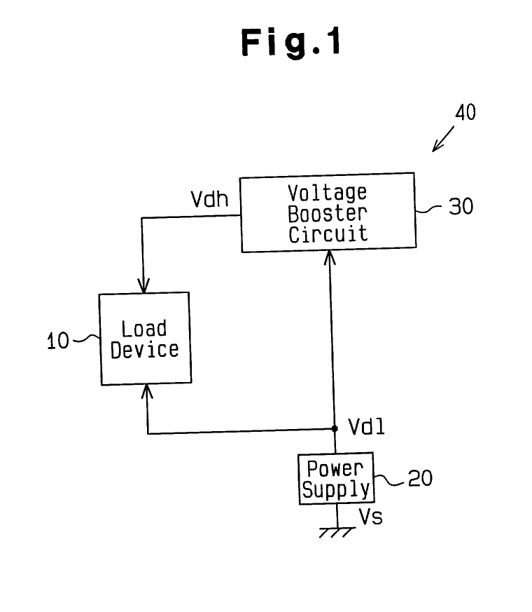

A voltage boost system 40 according to a preferred embodiment of the present invention will now be discussed with reference to FIG. 1. The voltage boost system 40 includes a load device 10, a power supply 20, and a voltage booster 30. The load device 10 has a low potential power supply terminal and a high potential power supply terminal. The power supply 20 provides the low potential power supply terminal with a first potential VD1. The voltage booster 30 provides the high potential power supply terminal with a second potential Vdh, which is higher than the first potential Vdl. The load device 10, for example, includes a source follower connected MOS transistor (not shown) and generates an output signal of a CCD shift register. The power supply 20 generates the first potential Vdl, which maintains a predetermined level with respect to a ground voltage Vs. The voltage booster 30, for example, includes a charge pump (not shown), which performs a clock operation, and generates the second potential Vdh by increasing the first potential Vdl, which is provided from the power supply 20.

When, for example, the first potential Vdl is set at 3.3V and the second potential Vdh is set at 8V in the voltage boost system 40, the low potential power supply terminal of the load device 10 is provided with an offset of 3.3V. However, 8V is applied to the high potential power supply terminal. Thus, a potential difference of 4.7V is applied to the load device 10. Accordingly, as long as the load device 10 is capable of withstanding the voltage, the load device 10 operates between the first potential Vdl (3.3V) and the second potential Vdh (8V).

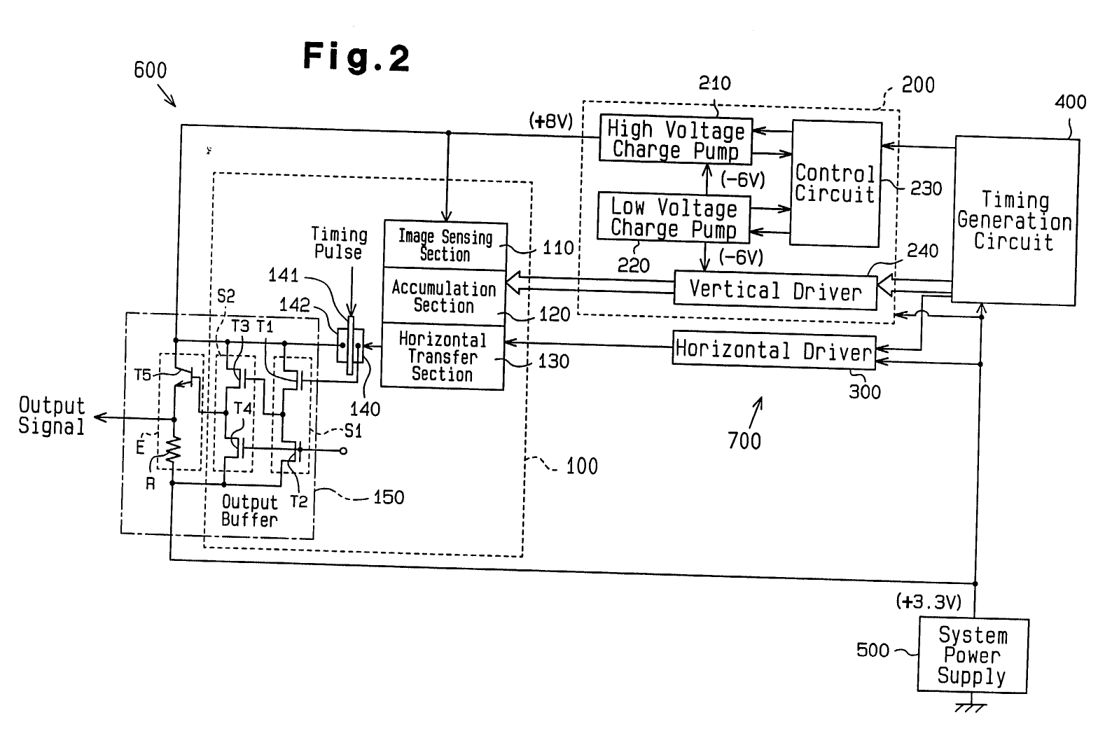

An image sensing apparatus 600 that includes the voltage boost system of the preferred embodiment will now be discussed with reference to FIG. 2.

The image sensing apparatus 600 includes a CCD image sensor 100 and a drive circuit 700.

The CCD image sensor 100 includes an image sensing section 110, an accumulation section 120, a horizontal transfer section 130, a floating diffusion (FD) section 140, and an output buffer 150. The image sensing section 110 performs photoelectric transfer to generate charges. The accumulation section 120 temporarily accumulates charges. The horizontal transfer section 130 outputs the charges accumulated in the accumulation section 120. The FD section 140 detects potential changes caused by the charges. The output buffer 150 generates an output signal voltage (image sensing signal) based on the potential change of the FD section 140 and provides the output signal to a signal processing system. The output buffer 150 includes an emitter follower E, which is externally connected to the CCD image sensor 100.

As known in the art, the CCD image sensor 100 performs the operations of (1) simultaneously transferring charges, which have undergone photoelectric-transfer in the image sensing section 110, at a predetermined timing to the accumulation section 120 (vertical transfer), (2) transferring the charges, which have been transferred and accumulated in the accumulation section 120, to the horizontal transfer section 130 in units of rows (horizontal transfer), and (3) detecting the potential change caused by the charges transferred to the horizontal transfer section 130 and outputting an output signal from the output buffer 150.

The drive circuit 700 receives a power supply voltage from a sole system power supply 500 and drives the CCD image sensor 100. The drive circuit 700 includes a drive circuit IC 200, a horizontal driver 300, and a timing generation circuit 400.

The drive circuit IC 200 is a one-chip integrated circuit (IC), which includes a high voltage charge pump 210, a low voltage charge pump 220, a control circuit 230, and a vertical driver 240.

The vertical driver 240 applies a vertical transfer pulse signal to each gate (not shown) of the image sensing section 110 and the accumulation section 120 so that the image sensing section 110 and the accumulation section 120 perform vertical transfer. The vertical driver 240 outputs a pulse signal based on a timing signal output from the timing generation circuit 400. The wave-height value (i.e., pulse voltage) of the drive pulse signal of the vertical driver 240 is obtained from the output voltage (e.g., “−6V”) of the charge pump 220 and the power supply voltage (e.g., “3.3V”) of the system power supply 500.

The low voltage charge pump 220 performs a voltage boost operation in the negative voltage direction based on a voltage boost clock signal provided from the control circuit 230. The low voltage charge pump 220 includes three voltage boost stages (not shown), each of which is formed from a MOS transistor and a capacitor. Theoretically, each voltage boost stage operates to decrease the voltage from the ground voltage by the wave-height value (e.g., “3.3V”) of the voltage boost clock signal. The control circuit 230 controls the low voltage charge pump 220 so that the output voltage of the low voltage charge pump 220 is maintained at “−6V”.

The high voltage charge pump 210 includes a single voltage boost stage, which is formed from a MOS transistor and a capacitor. The control circuit 230 controls the high voltage charge pump 210 so that the high voltage charge pump 210 generates a constant output voltage of “+8V” using the output voltages of the low voltage charge pump 220 and the system power supply 500. That is, high voltage charge pump 210 generates a boosted voltage by boosting the power supply voltage. The output voltage (boosted voltage) of the high voltage charge pump 210 is used as the bias voltage of the CCD image sensor 100, the reset voltage of the FD section 140, and the drive voltage of the output buffer 150.

The voltage boost operations of the high voltage and low voltage charge pumps 210, 220 are performed only when the output of the image sensing signal is stopped. This prevents noise from mixing with the image sensing signal, which is output from the CCD image sensor 100. The capacitors of the high voltage and low voltage charge pumps 210, 220 are actually externally connected to the drive circuit IC 200.

The horizontal driver 300 applies a horizontal transfer pulse signal to the horizontal transfer section 130. The horizontal driver 300 outputs a pulse signal based on a timing signal received from the timing generation circuit. The wave-height value (i.e., pulse voltage) of the drive pulse signal output from the horizontal driver 300 is obtained only from the power supply voltage of the system power supply 500.

The drive circuit 700 drives the CCD image sensor 100 so that the vertical driver 240 vertically transfers the charges, which have undergone photoelectric transfer in the vertical driver 240, to the accumulation section 120. The charges transferred and accumulated in the accumulation section 120 are then horizontally transferred to the horizontal transfer section 130 by the horizontal driver 300. The horizontally transferred charges cause a potential change in the FD section 140. Based on the potential change, the output buffer 150 generates the output signal voltage (image sensing signal) and provides the output signal to the signal processing system (not shown).

When an image sensing signal is output from the output buffer 150, a timing pulse signal is applied to gate 141. This electrically connects a fixed potential terminal 142 and the FD section 140 and resets the potential at the FD section 140. The reset operation completes preparation for receiving the next charge signal from the horizontal transfer section 130 in the FD section 140.

Since the reset operation requires high voltage, the output voltage of the high voltage charge pump 210 is used as described above. Further, the timing pulse signal used for the resetting is generated based on the timing signal output from the timing generation circuit 400, and the weight-height value of the timing pulse signal is obtained from the power supply voltage of the system power supply 500. A direct current component having about 2V, which is generated by dividing the output voltage of the high voltage charge pump 210, is added to the timing pulse signal as an offset voltage.

The output buffer 150 impedance-converts the signal of the FD section 140. The output buffer 150 includes n-channel enhancement MOS transistors T1, T2, which function as a source follower S1, n-channel MOS transistors T3, T4, which function as a source follower S2, and a bipolar transistor T5 and a resistor R, which form an emitter follower E.

The output signal of the FD section 140 is provided to the gate terminal of the transistor T1. The output signal of the source follower S1 is provided to the gate terminal of the transistor T3. The output signal of the source follower S2 is provided to the base terminal of the transistor T5. The output voltage signal of the emitter follower E is provided to the signal processing system as the image sensing signal of the CCD image sensor 100.

The high potential power supply terminal of the output buffer 150 (i.e., the high potential power supply terminals of the source followers S1, S2 and the emitter follower E) is connected to the high voltage charge pump 210. The low potential power supply terminal of the output buffer 150 (i.e., the low potential power supply terminals of the source followers S1, S2 and the emitter follower E) is connected to the system power supply 500. Accordingly, the boosted voltage of the high voltage charge pump 210 and the power supply voltage of the system power supply 500 are applied as a drive voltage to the source followers S1, S2 and the emitter follower E.

The gate terminals of the transistors T2, T4 in the source followers S1, S2 are connected to each other. The transistors T2, T4 are constant current sources. A voltage of about “5V”, which is generated through resistance dividing and included between the boosted voltage (+8V) of the high voltage charge pump 210 and the power supply voltage (+3.3V) of the system power supply 500, is applied to the gate terminals of the transistors T2, T4. When a ground potential is provided to the low potential power supply terminal of the output buffer 150, a voltage of, for example, about “2V” is applied to the gates of the transistors T2, T4.

In this manner, a voltage in the vicinity of the reset potential of the FD section 140 is applied to the drain terminals of the transistors T1, T3 and the collector terminal of the transistor T5, and a voltage of about “5V” is applied to the gates of the transistors T2, T4. Accordingly, even though the low potential power supply terminals of the source followers S1, S2, which include the transistors T2, T4 that serve as constant current sources, are connected to the system power supply 500, the source followers S1, S2 and the emitter follower E function properly. Further, the output buffer 150 functions at a voltage included between the output voltage of the high voltage charge pump 210 and the power supply voltage of the system power supply 500. This decreases the power consumption of the output buffer 150.

Further, the current consumption of the output buffer is relatively small. Thus, the capacitance of the capacitor of the voltage booster, which increases the power supply voltage of the sole system power supply 500, may be decreased. The high voltage and low voltage charge pumps 210, 220 perform voltage boost operations only when the CCD image sensor 100 stops outputting the image sensing signal. Accordingly, the capacitors of the high voltage and low voltage charge pumps 210, 220 must have a capacitance that enables stable driving with the charges accumulated during the limited voltage boost period. In the preferred embodiment, the power consumption of the output buffer 150 is relatively low. This decreases the capacitance of the capacitors in the high voltage and low voltage charge pumps 210, 220. Further, the size of the voltage boost system may be reduced.

Accordingly, the image sensing apparatus 600 of the preferred embodiment has the advantages described below.

(1) The high potential power supply terminal of the output buffer 150 is connected to an output terminal of the high voltage charge pump 210, and the low potential power supply terminal of the output buffer 150 is connected to the system power supply 500. This decreases power consumption when the output buffer 150 is driven. Further, the decrease in the power consumption decreases the capacitance of the capacitors in the high voltage and low voltage charge pumps 210, 220 and enables the size of the voltage boost system to be reduced.

(2) The voltage boost operations of the high voltage and low voltage charge pumps 210, 220 are performed only when the CCD image sensor 100 stops outputting the image signal. Accordingly, when the high voltage and low voltage charge pumps 210, 220 are integrated with the vertical driver 240, noise is prevented from mixing with the image sensing signal.

It should be apparent to those skilled in the art that the present invention may be embodied in many other specific forms without departing from the spirit or scope of the invention. Particularly, it should be understood that the present invention may be embodied in the following forms.

(a) In an environment in which noise is prevented from mixing with the image sensing signal, the voltage boost operation may be constantly performed.

(b) The high voltage charge pump 210 performs the voltage boost operation based on the voltage of the low voltage charge pump 220 and the voltage of the system power supply 500. However, the voltage boost operations may be performed in other ways. Further, the configurations of the low voltage charge pump 220 and the high voltage charge pump 210 may be changed as required.

(c) Circuits other than the charge pump circuit may be employed as the voltage booster.

(d) The high potential power supply terminal of the output buffer 150 is connected directly to the high voltage charge pump 210, and the low potential power supply terminal of the output buffer 150 is directly connected to the system power supply 500. However, the output buffer 150 may be connected between the high voltage charge pump 210 and the system power supply 500 in other ways.

(e) In the preferred embodiment, the gate potentials of the transistors T2, T4, which function as constant current sources, are adjusted to connect the low potential power supply terminal of the output buffer 150 to the system power supply 500. However, the transistor characteristic of each of the source followers S1, S2 and the emitter follower E in the output buffer 150 may be varied in accordance with the voltage provided to the low potential power supply voltage to connect the low potential power supply of the output buffer 150 to the system power supply 500.

(f) The output buffer 150 need not be formed by the two source followers S1, S2 and the emitter follower E and may have other configurations.

(g) In addition to the CCD, the device characteristic or circuit characteristic of a load device, which does not require the applied voltage to be used as the drive voltage, may be varied by applying a predetermined offset voltage to the low potential power supply terminal of the load device.

The present examples and embodiments are to be considered as illustrative and not restrictive, and the invention is not to be limited to the details given herein, but may be modified within the scope and equivalence of the appended claims.

What is claimed is:

1. A voltage boost system comprising:
a load device including a pair of terminals;
a power supply for generating a first potential; and
a voltage booster connected to the power supply for generating a second potential by boosting the first potential, wherein the second potential is provided to one of the pair of the terminals of the load device, and the first potential is provided to another one of the pair of the terminals of the load device.

2. The voltage boost system according to claim 1, wherein the load device is provided with an offset voltage functioning as the first potential.

3. The voltage boost voltage according to claim 1, wherein the voltage booster includes a charge pump circuit operated based on a clock signal.

4. The voltage boost system according to claim 1, wherein the first potential is greater than a ground potential.

5. An image sensing apparatus comprising:
a solid-state image sensing apparatus for accumulating charges in correspondence with an object image and transferring the accumulated charges;
a drive circuit connected to the solid-state image sensing apparatus for driving the solid-state image sensing apparatus so that the solid-state image sensing apparatus accumulates charges for a predetermined time and transfers the accumulated charges;
an output circuit connected to the solid-state image sensing apparatus for generating an image sensing signal from the charges transferred by the solid-state image sensing apparatus, wherein the output circuit has a pair of terminals;
a power supply for generating a first potential; and
a voltage booster connected to the power supply for generating a second potential by boosting the first potential, wherein one of the pair of the terminals is provided with the second potential of the voltage booster, and another one of the pair of the terminals is provided with the first potential of the power supply.

6. The image sensing apparatus according to claim 5, wherein the solid-state image sensing apparatus has a horizontal scanning period or a vertical scanning period, and the voltage booster performs a boost operation during a blanking period in the horizontal scanning period or the vertical scanning period.

7. The image sensing apparatus according to claim 5, wherein the voltage booster includes a charge pump circuit operated based on a clock signal.

8. The image sensing apparatus according to claim 5, wherein the first potential is greater than a ground potential.
